(19) United States
(12) Patent Application Publication
(10) Pub. No.: US 2009/0163637 A1
(43) Pub. Date: Jun. 25, 2009

(54) Filler system including densed fumed metal oxide

(76) Inventors: Zhifeng Li, Westford, MA (US); William R. Williams, Reading, MA (US); Michael P. Famiglietti, Haverhill, MA (US)

Correspondence Address: LAW DEPARTMENT;CABOT CORPORATION, 157 CONCORD ROAD, BILLERICA, MA, 01821, US

(21) Appl. No.: 12/228,778

(22) Filed: Aug. 14, 2008

Related U.S. Application Data
(60) Provisional application No. 61/008,651, filed on Dec. 21, 2007.

(51) Int. Cl. C09D 1/00

(52) U.S. Cl. 524/413; 106/287.17; 106/287.34; 106/287.19; 106/287.18; 524/432; 524/430

(57) ABSTRACT

A curable coating composition includes a polymer precursor and at least 6% by weight of a densed fumed metal oxide having a DBP number of at least 65% of the DBP number of an undensed fumed metal oxide of the same composition, surface area, and surface chemistry. The curable coating composition is at most 70% as viscous as a composition having the same components and the same weight fraction of the undensed fumed metal oxide.

### REFERENCE TO RELATED APPLICATIONS

This application claims priority from U.S. Provisional Application No. 61/008,651, filed Dec. 21, 2007, the entire contents of which are incorporated herein by reference.

### BACKGROUND OF THE INVENTION

1. Field of the Invention

The present invention relates to curable coating compositions containing densed fumed metal oxides.

2. Description of the Related Art

Metal oxide powders are often used in polymers to modify mechanical or other properties of the resulting composite. For example, fumed silica is a well-known reinforcing filler often employed to improve the physical properties of organic rubber and silicone rubber and sealants. Fumed silica often has a pour bulk density of about 25 kg/m³ to 64 kg/m³. A major disadvantage of such low bulk density powders is that they are relatively expensive to ship and store. In addition, because of the relatively low mass per volume in comparison to bulk (unpowdered) material, it can take a long time to feed a desired amount to compounding equipment, increasing the production time for filled products such as sealants.

To overcome this problem, the bulk density of metal oxide powders may be increased by a variety of methods. For example, U.S. Pat. No. 6,156,285 discloses a method employing a screw feeder to compress particulate silica, which is then combined with silicone to form a sealant. Likewise, U.S. Pat. No. 4,307,023 discloses that fumed silica may be compacted using a ball mill, rolls, or a vacuum method for use in silicone sealants and caulks.

Certain methods of densifying metal oxide powders not only reduce the bulk density of the powder but also reduce the structure of fumed metal oxides. As noted above, such metal oxide powders may be used in sealants. In addition, destructured metal oxides are considered advantageous for use in coatings and lacquers because they do not thicken the coating system, which reduces its spreadability (see, for example, U.S. Patent Publication No. 2002-0077388). Deagglomerated metal oxides, dispersed by jet dispersion for use in lacquers, are also disclosed in U.S. Pat. No. 6,020,419. The jet dispersed oxides avoid the contamination that may be present in mechanically destructured metal oxide powders but still employ deagglomeration to reduce the thixotropic effects of fully structured metal oxides.

Although processes for modifying the density of fumed metal oxides are known, there remains a need for fumed metal oxides that improve the mechanical properties of polymer composites into which they are incorporated without sacrificing or reducing the clarity of such composites. In addition, a need remains for a fumed metal oxide that is easy to disperse into a polymer or resin precursor without dramatically increasing viscosity and decreasing spreadability, thereby providing an advantageous alternative to previously known fumed metal oxides.

### SUMMARY OF THE INVENTION

In one aspect, the invention is a curable coating composition. The curable coating composition comprises a polymer precursor and at least 6% by weight of a densed fumed metal oxide with respect to the total weight of the polymer precursor and the densed fumed metal oxide, the densed fumed metal oxide having a DBP number of at least 65% of the DBP number of an undensed fumed metal oxide of the same composition, surface area, and surface chemistry. The curable coating composition is at most 70% as viscous as a composition having the same components and the same weight fraction of the undensed fumed metal oxide.

The densed fumed metal oxide may be a modified densed fumed metal oxide comprising, consisting essentially of, or consisting of the product formed from the contact between densed fumed metal oxide particles and a hydrophobizing agent. Alternatively, the densed fumed metal oxide may be a densed modified fumed metal oxide, the modified fumed metal oxide comprising, consisting of, or consisting essentially of the product formed from the contact between fumed metal oxide particles and the hydrophobizing agent.

The polymer precursor may be a precursor of a silicone rubber, an epoxy, an acrylate, a methacrylate, a polystyrene, a polyether, a polyester, a polycarbonate, a poly vinyl butyral, a polyurethane, a polyolefin, a co-polymer of any of these, or a mixture of any of these. The polymer precursor may be dissolved in a solvent. The curable coating composition is curable by exposure to an elevated temperature, exposure to electromagnetic radiation, exposure to an initiator at room temperature, or evaporation of a solvent in which the polymer precursor is suspended or dissolved.

A tap density of the densed fumed metal oxide may be from 1.75 to 4 times the tap density of a fumed metal oxide having the same surface area, composition, and surface chemistry but that has not been densed or destructured. The fumed metal oxide may be selected from fumed alumina, fumed silica, fumed zirconia, fumed titania, fumed ceria, fumed zinc oxide, and mixtures of any of these with each other. The curable coating composition may be curable to form a cured coating that is at least 85% transparent to electromagnetic radiation having a wavelength from 400 to 700 nm.

In another aspect, the invention is a curable coating composition. The curable composition comprises a polymer precursor and a densed fumed metal oxide. When the curable coating composition is deposited on a substrate and cured to form a cured coating, the cured coating exhibits less than 50 mg weight loss after abrasion for 1000 cycles under 1000 g load in a Taber Abraser with CS-10 wheels.

The densed fumed metal oxide may be a modified densed fumed metal oxide comprising, consisting essentially of, or consisting of the product formed from the contact between densed fumed metal oxide particles and a hydrophobizing agent. Alternatively, the densed fumed metal oxide may be a densed modified fumed metal oxide, the modified fumed metal oxide comprising, consisting of, or consisting essentially of the product formed from the contact between fumed metal oxide particles and the hydrophobizing agent. The densed fumed metal oxide may have a DBP number of at least 65% of the DBP number of an undensed fumed metal oxide of the same composition, surface area, and surface chemistry.

The curable coating composition may include at least 1 weight percent of the densed fumed metal oxide with respect to the total weight of the polymer precursor and the densed fumed metal oxide. The curable coating composition may be curable to form a cured coating that is at least 85% transparent to electromagnetic radiation having a wavelength from 400 to 700 nm.

In another aspect, the invention is a method of preparing a curable coating composition. The method includes providing a densed fumed metal oxide having a DBP number of at least 65% of the DBP number of an undensed fumed metal oxide of the same composition and combining the densed fumed metal oxide with a polymer precursor to form the curable coating composition containing at least 6% by weight of the densed fumed metal oxide with respect to the total weight of the polymer precursor and the densed fumed metal oxide. The curable coating composition is at most 70% as viscous as a composition having the same components and the same weight fraction of the undensed fumed metal oxide.

The densed fumed metal oxide may be hydrophobic. Providing may include providing a fumed metal oxide powder and reducing a bulk density of the fumed metal oxide powder to produce the densed fumed metal oxide. Alternatively or in addition, providing may include contacting a fumed metal oxide with a hydrophobizing agent and reducing a bulk density of the resulting product to produce the densed fumed metal oxide. Alternatively or in addition, providing may include contacting a densed fumed metal oxide with a hydrophobizing agent.

In another aspect, the invention is a method of preparing a curable coating composition. The method includes providing a densed fumed metal oxide and combining the densed fumed metal oxide with a polymer precursor to form the curable coating composition. When the curable coating composition is deposited on a substrate and cured to form a cured coating, the cured coating exhibits less than 50 mg weight loss after abrasion for 1000 cycles under 1000 g load in a Taber Abraser with CS-10 wheels.

Providing may include providing a fumed metal oxide powder and reducing a bulk density of the fumed metal oxide powder to produce the densed fumed metal oxide, such that the DBP number of the densed fumed metal oxide is at least 65% of the DBP number of the fumed metal oxide powder. Providing may further include contacting the fumed metal oxide with a hydrophobizing agent either before or after reducing the bulk density. Alternatively or in addition, providing may further include contacting the densed fumed metal oxide with a hydrophobizing agent to produce a modified densed fumed metal oxide for use in combining the densed fumed metal oxide with a polymer precursor.

In another aspect, the invention is a cured coating formed by disposing on a substrate a curable coating composition including a polymer precursor and at least 6% by weight of a densed fumed metal oxide with respect to the total weight of the polymer precursor and the densed fumed metal oxide, the densed fumed metal oxide having a DBP number of at least 65% of an undensed fumed metal oxide of the same composition, surface area, and surface chemistry, and curing the polymer precursor to form the cured coating. The curable coating composition is at most 70% as viscous as a composition having the same components and the same weight fraction of the undensed fumed metal oxide.

In another aspect, the invention is a cured coating formed by disposing a curable coating composition comprising a polymer precursor and a densed fumed metal oxide on a substrate and curing the polymer precursor to form the cured coating, wherein the cured coating exhibits less than 50 mg weight loss after abrasion for 1000 cycles under 1000 g load in a Taber Abraser with CS-10 wheels.

In another aspect, the invention is a curable coating composition. The curable coating includes a polymer precursor and at least 6% by weight of a densed modified fumed silica having a tap density from about 125 to about 145 g/L and a BET surface area from about 100 to about 140 m²/g. The modified fumed silica comprises, consists essentially of, or consists of the product formed from the contact between fumed silica particles and dimethyldichlorosilane.

In another aspect, the invention is a curable coating composition. The curable coating composition includes a polymer precursor and at least 6% by weight of a densed fumed silica having a tap density from about 135 to about 150 g/L and a BET surface area from about 175 to about 225 m²/g. The densed fumed silica is a modified densed fumed silica comprising, consisting essentially of, or consisting of the product formed from the contact between densed fumed silica particles and 3-methacryloxypropyltrimethoxysilane.

It is to be understood that both the foregoing general description and the following detailed description are exemplary and explanatory only and are intended to provide further explanation of the present invention, as claimed.

### BRIEF DESCRIPTION OF THE DRAWING

The invention is described with reference to the several figures of the drawing, in which,

FIG. 1 is a graph showing the percentage weight loss after 1000 abrasion cycles on various coating compositions.

FIG. 2 is a graph showing the percent transmission through various coatings at wavelengths between 300 and 800 nanometers.

### DETAILED DESCRIPTION OF THE INVENTION

It has surprisingly been found that curable coating compositions incorporating fumed metal oxides that have been densed may improve the mechanical properties of such coatings, especially with respect to abrasion. Furthermore, it has been observed that dispersions of densed fumed metal oxides exhibited improved clarity with respect to dispersions of destructured powders and were easier to produce in comparison to dispersions of undensed or destructured powders. Higher loadings of these densed fumed metal oxides may be employed in such coating compositions, thereby increasing the reinforcing and chemical resistance properties provided by the particles, without substantially increasing the viscosity of the coating compositions used to prepare the coatings. The densed fumed metal oxides may be surface treated before or after densing to increase their compatibility with a particular matrix material.

As used herein, densed powders are powders whose tap density have been increased in such a way that their structure is substantially maintained. That is, densing fumed metal oxide powders does not significantly alter the particles from their normal fractal dimension. In certain embodiments, the DBP number of the densed fumed metal oxide is at least about 65% of the DBP number of the undensed material, for example, at least about 70%, at least about 80%, or at least about 90% of the DBP number of the undensed material (e.g., a material having the same composition, surface chemistry, and surface area but that has not been densed).

DBP (dibutyl phthalate) absorption is a measure of the fumed metal oxide structure and is routinely used in the industry. DBP number may be measured using an absorptometer. A constant-rate burette is used to add oil to a sample of fumed metal oxide in the mixing chamber of an absorptometer. As the sample absorbs the oil, the viscosity of the mixture increases. This increased viscosity is transmitted to the torque sensing system of the absorptometer. The volume of oil added is read from the direct-reading burette. As used herein, DBP number is reported using the volume of oil per unit mass of fumed metal oxide at 70% of the maximum torque measured.

Any fumed metal oxide may be exploited in various embodiments of the invention. Exemplary fumed metal oxides include but are not limited to fumed silica, fumed alumina, fumed titania, fumed ceria, fumed zinc oxide, and fumed zirconia. In certain preferred embodiments, fumed silica is used. In certain other preferred embodiments, fumed zinc oxide is employed. In yet other preferred embodiments, fumed alumina and/or fumed titania are employed. Mixed metal oxides and mixtures of metal oxides may be employed as well. In certain preferred embodiments, densing increases the tap density of the powder from about 1.75 times to about 4 times, for example, from about 2 times to about 3 times, from about 3 times to about 4 times, or in any range defined by one or more of the end points listed herein. For example, the tap density of many undensed fumed silica grades is approximately 50 g/L. The tap density for many undensed fumed alumina grades is from about 60 g/L to about 80 g/L. The tap density for many undensed fumed titania grades is about 120 g/L, while that for certain undensed fumed zinc oxides is about 200 g/L. Tap density may be measured according to DIN/ISO 787/11.

In some embodiments, the tap density of densed fumed silica may be from about 75 g/L to about 200 g/L, for example, from about 95 g/L to about 130 g/L, from about 130 g/L to about 160 g/L, from about 160 g/L to about 195 g/L, or in any range defined by one or more of the end points listed above. The tap density for densed fumed alumina according to certain embodiments may be from about 105 to about 320 g/L, for example, from about 105 g/L to about 175 g/L, from about 175 g/L to about 250 g/L, from about 250 g/L to about 320 g/L, or in any range defined by one or more of the end points listed above. The tap density for densed fumed titania according to certain embodiments may be from about 210 g/L to about 520 g/L, for example, from about 210 g/L to about 300 g/L, from about 300 g/L to about 400 g/L, or from about 400 g/L to about 520 g/L, or in any range defined by one or more of the end points listed above. The tap density for densed fumed zinc oxide according to certain embodiments may be from about 350 g/L to about 800 g/L, for example, from about 350 g/L to about 500 g/L, from about 500 g/L to about 650 g/L, from about 650 g/L to about 800 g/L, or in any range defined by one or more of the end points listed above. Tap density may be measured according to DIN/ISO 787/11.

In some embodiments, the surface area of the fumed metal oxide, as measured by BET (Brunauer S, Emmett P H & Teller E. Adsorption of gases in multimolecular layers. Journal of the American Chemical Society 60:309-19, 1938) may be from about 1 to about 1000 m²/g, for example, from about 25 to about 800 m²/g, from about 40 to about 400 m²/g, from about 80 to about 120 m²/g, from about 30 to about 100 m²/g, from about 30 to about 50 m²/g, or in any range defined by one or more of the end points listed above.

In certain preferred embodiments, the densed fumed metal oxide is a densed modified fumed silica having a tap density from about 125 to about 145 g/L and a surface area from about 100 to about 140 m²/g. The modified fumed silica includes the product formed from the contact between fumed silica particles and dimethyldichlorosilane, which product is then densed. In certain other preferred embodiments, the densed fumed metal oxide is a densed modified fumed silica having a tap density from about 135 to about 150 m²/g and a surface area from about 175 to about 225 m²/g. The modified densed fumed silica includes the product formed from the contact between densed fumed silica particles and 3-methacryloxypropyltrimethoxysilane.

Various methods of densing the fumed metal oxide without significantly destructuring it are known to those of skill in the art. In an exemplary method, the fumed metal oxide powder is fed into a drum containing two rollers that rotate in opposite directions. The first drum is a filter drum within which a vacuum is created. As the drum rotates, the air passing through the powder into the drum causes the silica powder to compact. As the powder is drawn into the clearance between the filter drum and the second drum, termed the pressure drum, it is subjected to a further rolling pressure and densed even more. The densified product is stripped from the drums with a knife and dropped out of the apparatus. Other methods of densifying powders known to those of skill in the art may also be employed. Exemplary apparatus for densifying powders include the Vacupress available from Grenzebach BSH GmbH, Bad Hersfeld, Germany. Other methods are disclosed by U.S. Pat. Nos. 4,877,595, 4,326,852, and 6,156,285.

The fumed metal oxide may be further subjected to a surface treatment before or after densing to modify the surface chemistry of the metal oxide powder, for example, to render it hydrophobic. The treatment agent may be an oligomer or polymer or may be a non-polymeric material. The treatment agent may be a hydrophobizing agent. In certain embodiments, fumed silica or other fumed metal oxides may be modified by contacting it with one or more of 3-methacryloxypropyltrimethoxysilane, octamethylcyclotetrasiloxane, silicone fluid, dimethyldichlorosilane, hexamethyldisilazane, and octyltrimethylsiloxane under appropriate reaction conditions. Additional silanes with which the fumed metal oxides may be contacted include but are not limited to those silanes listed in U.S. Pat. No. 5,707,770. Exemplary silanes include but are not limited to compounds of the formula R₃SiX, cyclic siloxanes of the general formula (R₂SiO)_{y}, and linear siloxanes of the general formula R′₃Si—O—{Si(R)₂—O}_{z}—SiR′₃, wherein each R′ is independently selected from the group consisting of aliphatic hydrocarbon and fluorocarbon radicals of 6 carbon atoms or less (e.g., methyl, trifluoromethyl, ethyl, pentafluoroethyl, propyl, butyl, isopropyl, tert-butyl, amyl, etc.), phenyl radicals (e.g., phenyl, tolyl, fluorophenyl, chlorophenyl, nitrophenyl, hydroxyphenyl, etc.), and hydroxyl radicals, each R is independently selected from the group consisting of aliphatic hydrocarbon radicals of 6 carbon atoms or less and phenyl radicals, each X is independently selected from the group consisting of halogen radicals (e.g., chloro, bromo, iodo, etc.), and hydroxyl radicals and salts thereof (e.g., OH, O—Li, O—Na, O—K, etc.), y is 3 or 4, and z is an integer from 0 to 10, inclusive. Exemplary specific silanes include but are not limited to trimethylchlorosilane (TMCS), hexamethyldisiloxane (HMDS), octamethyltrisiloxane, decamethyltetrasiloxane, hexamethylcyclotrisiloxane, hydroxy terminated polydimethylsiloxane, and octamethylcyclotetrasiloxane.

Methods of modifying the surface of fumed metal oxides are well known to those of skill in the art, and exemplary methods are described in U.S. Pat. Nos. 6,090,439, 6,159,540, 6,334,240, 5,928,723, 5,989,768, and 5,429,873, and U.S. Patent Publications Nos. 20030194550 and 20060269465. In exemplary embodiments, the fumed metal oxide and treating agent are charged into a reactor and maintained at an appropriate temperature until a desired extent of reaction is achieved.

Densed fumed metal oxides may be combined with a vehicle and a curable polymer precursor, for example, a liquid phase polymer precursor, to form a curable coating composition. The curable coating composition may be formed using any method known to those skilled in the art, including, for example, using high shear mixing. Furthermore, the compositions may be prepared using a dispersion of fumed metal oxides in a solvent. The amount of fumed metal oxide in the curable coating composition may be at least about 1% by weight with respect to the total weight of the polymer precursor and the fumed metal oxide, for example, at least about 5%, at least about 6%, at least about 7%, at least about 10%, at least about 15%, at least about 20%, at least about 30%, or at least about 40%. In certain embodiments, a viscosity of the curable coating composition is at most 70%, for example, at most 60%, at most 50%, at most 40%, or at most 30%, of the viscosity of a composition having the same components and the same weight fraction of the undensed fumed metal oxide. The amount of fumed metal oxide may be such that, when the coating composition is used to form a curable coating and subsequently cured, the resulting cured coating includes greater than or equal to about 1 wt % of the fumed metal oxide based on the total weight of the coating, for example, at least about 5%, at least about 6%, at least about 7%, at least about 10%, at least about 15%, at least about 20%, at least about 30%, or at least about 40%.

The curable coating composition can be formed with a minimum of additional components (additives and/or cosolvents) and processing steps. However, additives such as dispersants and cosolvents may also be included. For example, when a photosensitive polymer precursor is used, a photoinitiator can also be added. Other curable monomers and/or oligomers may also be added.

In a further embodiment, a curable coating is prepared from the curable coating composition. The curable coating may include a polymer precursor, for example, a liquid phase polymer precursor, and a densed fumed metal oxide. The polymer precursor and the densed fumed metal oxide can be any of those described in more detail herein. The curable coating can be a photosensitive coating from which a cured coating may be fabricated by irradiating the curable coating, or a thermosensitive coating, from which a cured coating is fabricated by thermal treatment of the curable coating. Alternatively or in addition, the curable coating may be cured by evaporation of a solvent in which the polymer precursor is suspended or dissolved, e.g., as for a lacquer. In some embodiments, the curable coating composition may be cured by exposure to an initiator at room temperature. As used herein, a curable coating composition is a material that is cured to form an adherent film after application onto a substrate. It is not necessary that the curable coating composition be cured by an increase in molecular weight or crosslink density of the polymer precursor. The amount of densed fumed metal oxide in the curable coating may be at least about 1% by weight of the fumed metal oxide based on the total weight of the coating, for example, at least about 5%, at least about 6%, at least about 7%, at least about 10%, at least about 15%, at least about 20%, at least about 30%, or at least about 40%. The amount of densed fumed metal oxide may be such that, when the curable coating is subsequently cured, the resulting cured coating includes greater than or equal to about 1% by weight of the fumed metal oxide based on the total weight of the coating, for example, at least about 5%, at least about 6%, at least about 7%, at least about 10%, at least about 15%, at least about 20%, at least about 30%, or at least about 40%.

In another embodiment, a cured coating is prepared from the curable coating. The cured coating may include a cured polymer precursor and a densed fumed metal oxide. The cured coating may include greater than or equal to about 1 wt % of the fumed metal oxide based on the total weight of the coating, for example, at least about 5%, at least about 6%, at least about 7%, at least about 10%, at least about 15%, at least about 20%, at least about 30%, or at least about 40%.

The polymer precursor may include precursors for any cured resin known in the art. Exemplary cured resins include but are not limited to phenolic resins, e.g., epoxy bisphenol-A resin or epoxy novolac resin, and may also include but are not limited to cured polymers or resins such as epoxies, poly vinyl acrylates, poly vinyl methacrylates, copolymers and esters of acrylate and methacrylate polymers, polystyrenes, polyethers, polyesters, polycarbonates, a poly vinyl butyral, polyurethanes, polyolefins, styrene-acrylic resins, silicone resins, and mixtures of any of these. Likewise, polymers, oligomers, and monomers may be included in the polymer precursor and may be thermally or radiation polymerizable or cross-linkable. For example, monomers or oligomers of the above resins or other resins or polymers, such as acrylates, methacrylates, epoxides, terminal alkenes, diisocyanates, diols, diamines and styrenics, may be included in the curable coating composition in addition to or as alternatives to the polymer precursors described above or as mixtures with each other. Prepolymers for polyurethanes and polyureas, such as hydroxyl-, amine-, or isocyanate-terminated oligomers, may also be employed either alone or in combination with any of the other polymer precursors disclosed herein. Polymer precursors that are commonly employed for lacquers, such as those listed in U.S. Patent Publication No. 20060009545, are also appropriate for use in various embodiments. When the coating is intended for use as a lacquer, the polymer precursor may include one or more of the polymers described herein, which may in turn be dissolved in a solvent. When the components of the curable coating composition are curable by irradiation, the curable coating composition may further comprise a photoinitiator, which generates a radical on absorbing light with the respective pigment.

The curable coating composition may also include a solvent or dispersant. Exemplary solvents include but are not limited to alcohols, glycols, ethers (such as tetrahydrofuran or diethylether), ketones (such as acetone, methylethyl ketone, or methylbutyl ketone), esters (such as n-butyl propionate), acetates (such as ethyl acetate), amides (such as dimethylformamide), sulfoxides (such as dimethylsulfoxide), hydrocarbons, and miscible mixtures thereof, such as ethylene glycol and methanol. The solvent may also include water. Solvents that are particularly suited for lacquers include but are not limited to aromatic, aliphatic, araliphatic or cycloaliphatic hydrocarbons, partially or completely halogenated aromatic, aliphatic, araliphatic or cycloaliphatic hydrocarbons, alcohols, such as, for example, methanol, ethanol, isopropanol, butanol, benzyl alcohol, diacetone alcohol, esters, such as, for example, ethyl acetate, propyl acetate, butyl acetate, ether esters, such as, for example, methoxypropyl acetate or butyl glycol acetate, ketones, such as acetone, methyl ethyl ketone, methyl isobutyl ketone or cyclohexanone, strongly polar solvents, such as, for example, N,N-dimethylformamide, N,N-dimethylacetamide, dimethyl sulfoxide, N-methylpyrrolidone, water, liquid acid esters, such as, for example, phosphoric acid dibutyl ester, phosphoric acid tributyl ester, sulfonic acid esters, and borates or derivatives of silica, for example tetraethoxysilane, methyltrimethoxysilane, 3-aminopropyltrimethoxysilane, 3-aminopropyltriethoxysilane, glycidyloxypropyltrimeth-oxysilane, or glycidyloxypropyltriethoxysilane.

The curable resin, polymer, monomer, or oligomer may be chosen to be compatible (i.e., form a one-phase combination) with the other materials of the curable coating composition. In some embodiments, the polymer-liquid interaction parameter x describing the composition is less than or equal to 0.5. A solubility parameter may also be used to indicate compatibility, as discussed in Polymer Handbook, J. Brandrup, ed., pp. VII 519-557 (1989), incorporated herein by reference. The solubility parameter may also be employed to optimize the choice of modification for the fumed metal oxide, the solvents and dispersants employed in the curable coating composition, or any other material used to form the coating.

Coating compositions according to various embodiments incorporating densed fumed metal oxides can accommodate higher loadings without dramatically increasing viscosity buildup. That is, higher loadings of filler may be used to improve the mechanical properties of cured coatings, including wear and scratch resistance, but without decreasing the spreadability or shelf life of the coating compositions. Cured coatings produced using curable coating compositions according to various embodiments may be at least 85% transparent to electromagnetic radiation having a wavelength from 400 nm to 700 nm, for example, at least 90% transparent. Alternatively or in addition, such coatings may exhibit less than 50 mg weight loss, for example, less than 40 mg weight loss, after abrasion for 1000 cycles under 1000 g load in a Taber Abraser with CS-10 wheels. In certain embodiments, the weight loss may be less than 75% of the weight loss from a coating having the same composition but produced without fumed metal oxide powder.

The present invention will be further clarified by the following examples which are intended to be only exemplary in nature.

### EXAMPLES

### Example 1

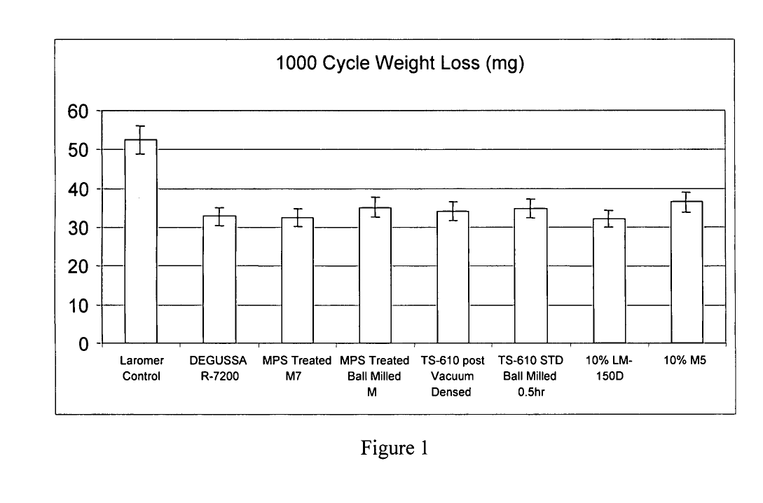

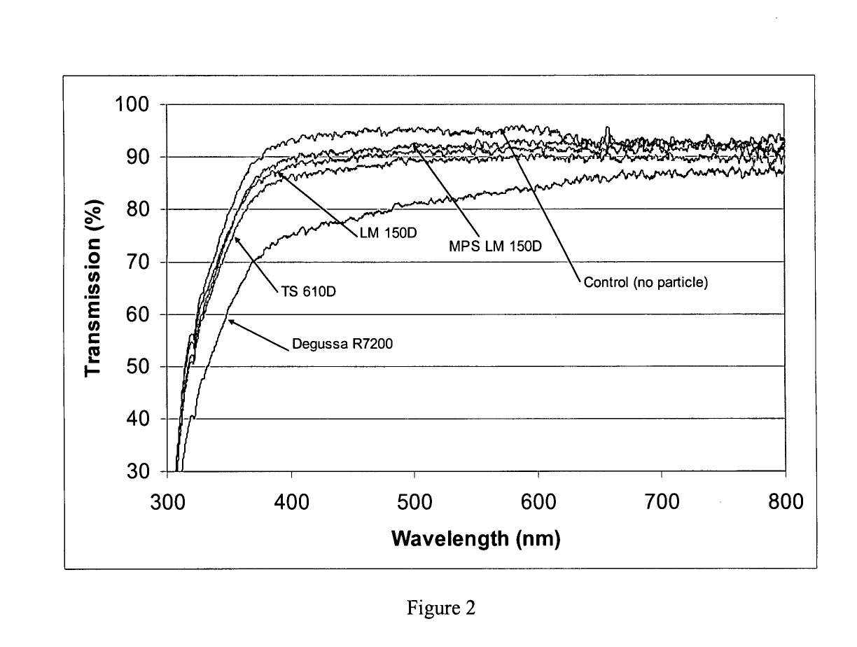

Fumed silica of the grades outlined below was combined at a 10 weight % loading with Laromer PO43F, a UV curable acrylic resin available from BASF, to form a resin-particle mixture. The viscosity of the uncured mixture was determined by measuring the shear stress with respect to shear rate of the mixture on a AR2000 Rheometer and calculating viscosity using a Herschel-Bulkley Model over a shear rate range of 1-100 s⁻¹. The mixture was also spread as an approximately 30 micron layer on a stainless steel substrate and cured by exposure to UV light according to the manufacturer's instructions. The resulting coatings were evaluated for light transmission and tribology. Each coating was abraded for 1000 cycles and the weight loss and gloss retention recorded. Abrasion testing was performed on a Taber Abraser using CS-10 abrasion wheels under a 1000 g load. Samples were abraded for 10 sets of 100 cycles. After each 100 cycle abrasion set, the abrasion wheels were refaced using an S-11 refacing disk for 25 cycles under a 1000 g load. The results are shown in Table 1 and FIGS. 1 and 2.

As shown in Table 1, resin-particle mixtures containing densed fumed silicas exhibited dramatically reduced viscosity in comparison to undensed fumed silicas for both treated and untreated silica grades. For a given grade, the reduction was comparable to the results from ball-milled (destructured) silicas (Comparative Examples 1, 3, and 5). In addition, the abrasion performance of coatings formed from milled or densed coatings is comparable (FIG. 1). FIG. 2 shows the advantages that can be gained from the use of densed silicas rather than ball-milled silicas. FIG. 2 shows that filled resins containing densed silicas exhibit light transmission comparable to that of unfilled resin across almost the entire visible light spectrum, with a difference of less than 10% at very low wavelengths. In contrast, resins filled with a destructured silica exhibit close to 20% less transmission at low wavelengths in comparison to unfilled resins and more than 10% less transmission at red wavelengths in the visible spectrum. Without being bound by any particular theory, it is believed that densed powders are more uniformly dispersed into resins and other polymer matrices, thereby decreasing the amount of large particulates within the composite that can scatter light and reduce clarity. In addition, ball-milling may introduce impurities into the powder that have abraded off the milling media. These impurities may further reduce clarity.

TABLE 1

| | Coating Description (10 wt % | | | |
|---|---|---|---|---|
| | particles in Laromer | Viscosity | Tap Density of | DBP # of filler |
| Example | PO43F) | (cP) | filler (g/L) | (cm³/100 g) |
| Control | *Laromer Control | 195 | — | — |
| Comparative 1 | *Degussa Aerosil ® R7200 | 337 | 202 | 128 |
| | (MPS treated, destructured) | | | |
| Comparative 2 | MPS treated Cab-O-Sil ® M5 | 1358 | 68 | 329 |
| Example 1 | MPS treated Cab-O-Sil ® M- | 429 | 143 | 241 |
| | 7D | | | |
| Comparative 3 | Ball Milled MPS treated | 468 | 162 | 203 |
| | Cab-O-Sil ® M5 | | | |
| Comparative 4 | Cab-O-Sil ® TS-610 | 1276 | 61 | 246 |
| Example 2 | Densed Cab-O-Sil ® TS-610 | 435 | 135 | 220 |
| Comparative 5 | Ball Milled Cab-O-Sil ® | 402 | 228 | 143 |
| | TS-610 | | | |
| Comparative 6 | Cab-O-Sil ® LM-150 | 1395 | 56 | 284 |
| Example 3 | Cab-O-Sil ® LM-150D | 945 | 86 | 297 |
| | (Densed LM-150) | | | |
| Comparative 7 | Cab-O-Sil ® M5 | 9344 | 50 | 302 |
| Example 4 | Cab-O-Sil ® M-7D (Densed | 3500 | 89 | 301 |
| | M5) | | | |

Except as indicated (*), all materials available from Cabot Corporation under the trademark Cab-O-Sil ®;
MPS = 3-methacryloxypropyltrimethoxysilane,
M5 = untreated, surface area (SA) = 200 m²/g;
TS-610 = dimethyldichlorosilane treated,
SA = 120 m²/g;
LM-150 = untreated,
SA = 160 m²/g

The foregoing description of preferred embodiments of the present invention has been presented for the purposes of illustration and description. It is not intended to be exhaustive or to limit the invention to the precise form disclosed. Modifications and variations are possible in light of the above teachings, or may be acquired from practice of the invention. The embodiments were chosen and described in order to explain the principles of the invention and its practical application to enable one skilled in the art to utilize the invention in various embodiments and with various modifications as are suited to the particular use contemplated. It is intended that the scope of the invention be defined by the claims appended hereto, and their equivalents.

What is claimed is:

1. A curable coating composition, comprising:
a polymer precursor; and
at least 6% by weight of a densed fumed metal oxide with respect to the total weight of the polymer precursor and the densed fumed metal oxide, the densed fumed metal oxide having a DBP number of at least 65% of the DBP number of an undensed fumed metal oxide of the same composition, surface area, and surface chemistry, wherein the curable coating composition is at most 70% as viscous as a composition having the same components and the same weight fraction of the undensed fumed metal oxide.

2. The curable coating composition of claim 1, wherein the densed fumed metal oxide is a modified densed fumed metal oxide comprising the product formed from the contact between densed fumed metal oxide particles and a hydrophobizing agent or a densed modified fumed metal oxide, the modified fumed metal oxide comprising the product formed from the contact between fumed metal oxide particles and the hydrophobizing agent.

3. The curable coating composition of claim 1, wherein the polymer precursor is a precursor of a silicone rubber, an epoxy, an acrylate, a methacrylate, a polystyrene, a polyether, a polyester, a polycarbonate, a poly vinyl butyral, a polyurethane, a polyolefin, a co-polymer of any of these, or a mixture of any of these.

4. The curable coating composition of claim 1, wherein the curable coating composition is curable by exposure to an elevated temperature, exposure to electromagnetic radiation, exposure to an initiator at room temperature, or evaporation of a solvent in which the polymer precursor is suspended or dissolved.

5. The curable coating composition of claim 1, wherein a tap density of the densed fumed metal oxide is from 1.75 to 4 times the tap density of a fumed metal oxide having the same surface area, composition, and surface chemistry but that has not been densed or destructured.

6. The curable coating composition of claim 1, wherein the fumed metal oxide is selected from fumed alumina, fumed silica, fumed zirconia, fumed titania, fumed ceria, fumed zinc oxide, and mixtures of any of these with each other.

7. The curable coating composition of claim 1, wherein the curable coating composition is curable to form a cured coating that is at least 85% transparent to electromagnetic radiation having a wavelength from 400 to 700 nm.

8. A curable coating composition, comprising:
a polymer precursor; and
a densed fumed metal oxide, wherein, when the curable coating composition is deposited on a substrate and cured to form a cured coating, the cured coating exhibits less than 50 mg weight loss after abrasion for 1000 cycles under 1000 g load in a Taber Abraser with CS-10 wheels.

9. The curable coating composition of claim 8, wherein the densed fumed metal oxide is a modified densed fumed metal oxide comprising the product formed from the contact between densed fumed metal oxide particles and a hydrophobizing agent or a densed modified fumed metal oxide, the modified fumed metal oxide comprising the product formed from the contact between fumed metal oxide particles and the hydrophobizing agent.

10. The curable coating composition of claim 8, wherein the densed fumed metal oxide has a DBP number of at least 65% of the DBP number of an undensed fumed metal oxide of the same composition, surface area, and surface chemistry.

11. The curable coating composition of claim 8, wherein the curable coating composition comprises at least 1 weight percent of the densed fumed metal oxide with respect to the total weight of the polymer precursor and the densed fumed metal oxide.

12. The curable coating composition of claim 8, wherein the tap density of the densed fumed metal oxide is from 1.75 to 4 times greater than the tap density of a fumed metal oxide having the same composition, surface area and surface chemistry but that has not been densed or destructured.

13. The curable coating composition of claim 8, wherein the curable coating composition is curable by exposure to an elevated temperature, exposure to electromagnetic radiation, exposure to an initiator at room temperature, or evaporation of a solvent in which the polymer precursor is suspended or dissolved.

14. The curable coating composition of claim 8, wherein the fumed metal oxide is selected from fumed alumina, fumed silica, fumed zirconia, fumed titania, fumed ceria, fumed zinc oxide, and mixtures of any of these.

15. The curable coating composition of claim 8, wherein the curable coating composition is curable to form a cured coating that is at least 85% transparent to electromagnetic radiation having a wavelength from 400 to 700 nm.

16. A method of preparing a curable coating composition, comprising:
providing a densed fumed metal oxide having a DBP number of at least 65% of the DBP number of an undensed fumed metal oxide of the same composition;
combining the densed fumed metal oxide with a polymer precursor to form the curable coating composition containing at least 6% by weight of the densed fumed metal oxide with respect to the total weight of the polymer precursor and the densed fumed metal oxide, wherein the curable coating composition is at most 70% as viscous as a composition having the same components and the same weight fraction of the undensed fumed metal oxide.

17. The method of claim 16, wherein providing comprises providing a fumed metal oxide powder and reducing a bulk density of the fumed metal oxide powder to produce the densed fumed metal oxide.

18. The method of claim 16, wherein providing comprises contacting a fumed metal oxide with a hydrophobizing agent and reducing a bulk density of the resulting product to produce the densed fumed metal oxide.

19. The method of claim 16, wherein providing comprises contacting a densed fumed metal oxide with a hydrophobizing agent.

20. The method of claim 16, wherein the fumed metal oxide is selected from fumed alumina, fumed silica, fumed zirconia, fumed titania, fumed ceria, fumed zinc oxide, and mixtures of any of these.

21. The method of claim 16, wherein the densed fumed metal oxide is hydrophobic.

22. The method of claim 16, wherein a tap density of the densed fumed metal oxide is from 1.75 to 4 times the tap density of a fumed metal oxide having the same surface area, composition, and surface chemistry but that has not been densed or destructured.

23. A method of preparing a curable coating composition, comprising:
providing a densed fumed metal oxide; and
combining the densed fumed metal oxide with a polymer precursor to form the curable coating composition, wherein, when the curable coating composition is deposited on a substrate and cured to form a cured coating, the cured coating exhibits less than 50 mg weight loss after abrasion for 1000 cycles under 1000 g load in a Taber Abraser with CS-10 wheels.

24. The method of claim 23, wherein providing comprises providing a fumed metal oxide powder and reducing a bulk density of the fumed metal oxide powder to produce the densed fumed metal oxide, such that the DBP number of the densed fumed metal oxide is at least 65% of the DBP number of the fumed metal oxide powder.

25. The method of claim 24, wherein providing further comprises contacting the fumed metal oxide with a hydrophobizing agent either before or after reducing the bulk density.

26. The method of claim 23, further comprising contacting the densed fumed metal oxide with a hydrophobizing agent to produce a modified densed fumed metal oxide for use in combining the densed fumed metal oxide with a polymer precursor.

27. The method of claim 23, wherein a tap density of the densed fumed metal oxide is from 1.75 to 4 times the tap density of a fumed metal oxide having the same surface area, composition, and surface chemistry but that has not been densed or destructured.

28. The method of claim 23, wherein the fumed metal oxide is selected from fumed alumina, fumed silica, fumed zirconia, fumed titania, fumed ceria, fumed zinc oxide, and mixtures of any of these.

29. A cured coating formed by disposing on a substrate a curable coating composition comprising a polymer precursor and at least 6% by weight of a densed fumed metal oxide with respect to the total weight of the polymer precursor and the densed fumed metal oxide, the densed fumed metal oxide having a DBP number of at least 65% of an undensed fumed metal oxide of the same composition, surface area, and surface chemistry, and curing the polymer precursor to form the cured coating, wherein the curable coating composition is at most 70% as viscous as a composition having the same components and the same weight fraction of the undensed fumed metal oxide.

30. A cured coating formed by disposing a curable coating composition comprising a polymer precursor and a densed fumed metal oxide on a substrate and curing the polymer precursor to form the cured coating, wherein the cured coating exhibits less than 50 mg weight loss after abrasion for 1000 cycles under 1000 g load in a Taber Abraser with CS-10 wheels.

31. A curable coating composition, comprising:
a polymer precursor; and
at least 6% by weight of a densed modified fumed silica having a tap density from about 125 to about 145 g/L and a BET surface area from about 100 to about 140 m²/g, wherein the modified fumed silica comprises the product formed from the contact between fumed silica particles and dimethyldichlorosilane.

32. A curable coating composition, comprising:
a polymer precursor; and
at least 6% by weight of a densed fumed silica having a tap density from about 135 to about 150 g/L and a BET surface area from about 175 to about 225 m²/g, wherein the densed fumed silica is a modified densed fumed silica comprising the product formed from the contact between densed fumed silica particles and 3-methacryloxypropyltrimethoxysilane.
